(19) United States
(12) Patent Application Publication
(10) Pub. No.: US 2011/0297591 A1
(43) Pub. Date: Dec. 8, 2011

(54) CONVEYOR SYSTEM FOR SEPARATING MIXED RECYCLED MATERIALS

(76) Inventors: Karl W. Schmidt, Commerce City, CO (US); Christopher R. Simon, Marietta, GA (US)

(21) Appl. No.: 12/795,159

(22) Filed: Jun. 7, 2010

(51) Int. Cl. B07B 13/00; B07B 13/10; B07B 4/00

(52) U.S. Cl. 209/635; 209/691

(57) ABSTRACT

A conveyor system for separating mixed recycled materials containing lighter and heavier recycled materials employs an inclined conveyor belt with a series of rows of rotating beaters striking the underside of the conveyor belt. A feeder mechanism deposits mixed recycled materials onto the midsection of the conveyor belt. Heavier recycled materials are bounced from the conveyor belt and tumble to the lower end, while lighter recycled materials are carried by motion of the conveyor belt to its upper end.

### BACKGROUND OF THE INVENTION

1. Field of the Invention

The present invention relates generally to the field of equipment for processing recycled materials. More specifically, the present invention discloses a conveyor system for separating mixed recycled materials.

2. Statement of the Problem

Various types of equipment have been used for many years to process mixed recycled materials, such as cans, bottles, paper and corrugated material. Recycled materials are typically collected from consumers and transported to collection centers in a mixed state, with cans, bottles, paper and corrugated material intermixed. These materials must be separated for subsequent processing and sale.

The prior art in this field includes a variety of disc screen devices for classifying recycled materials, as shown for example in U.S. Pat. Nos. 7,004,332 (Davis), 6,648,145 (Davis et al.), 6,250,478 (Davis), 6,076,684 (Bollegraaf) and 7,584,856 (Miller et al.), and U.S. Patent Application Pub, No. 2009/0152173 (Miller et al.). The disc screen has rows of irregular discs (e.g., with a generally square or triangular shape) mounted on a series of rotating shafts. The disc screen is inclined so that lighter flat items such as newspaper and cardboard ride to the top of the disc screen. Heavier recycled items such as bottles and cans are bounced by the rotating irregular discs and tumble to the bottom of the disc screen. The spacing between the discs and shafts allows smaller recycled items to fall through the disc screen.

Disc screen devices of this type have a significant shortcoming in that the rotating shafts and discs are exposed to the recycled materials being processed. Recycled materials often include items such as plastic bags, straps and bottles that can quickly foul the disc screen by becoming stuck between the discs and wrapped around the rotating shafts. This rapidly impairs the functionality of the disc screen and can eventually prevent operation of the system. The disc screen must be periodically shut down to remove such materials, which is time-consuming and can be dangerous.

Solution to the Problem. In contrast to prior art disc screen devices, the present invention employs a conveyor system for separating mixed recycled materials in which an array of beaters strike the underside of an inclined conveyor belt. The recycled materials contact only the upper surface of the conveyor belt, which protects the beaters and drive shafts from fouling. The conveyor carries lighter, two-dimensional recycled materials such as paper and cardboard to its upper end, while heavier, three-dimensional recycled items such as bottles and cans are bounced by the impact of the beaters on the underside of the conveyor belt and fall to the lower end of the conveyor.

Optionally, a blower can be used to blow air against the upper surface of the conveyor belt to help hold lighter, flat recycled items (i.e., paper and cardboard) on the conveyor belt as they are carried to upper end of the conveyor belt. This increases the effectiveness of the present invention in separating paper and cardboard from heavier items, such as cans and bottles.

### SUMMARY OF THE INVENTION

This invention provides a conveyor system for separating mixed recycled materials containing lighter and heavier recycled materials that employs an inclined conveyor belt with an array of rotating beaters striking the underside of the conveyor belt. A feeder mechanism deposits mixed recycled materials onto the midsection of the conveyor belt. Heavier recycled materials are bounced from the conveyor belt and tumble to the lower end, while lighter recycled materials are carried by motion of the conveyor belt to its upper end.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a simplified side cross-sectional view of the present conveyor system in operation.

FIG. 2 is a perspective view of the conveyor system.

FIG. 3 is a top view of the conveyor system with the conveyor belt removed to reveal the beaters 40.

FIG. 4 is a perspective view corresponding to FIG. 3.

FIG. 5 is an exploded perspective view of one of the smaller beater assemblies.

FIG. 5a is an exploded perspective view of one of the larger beater assemblies.

FIG. 6 is a side cross-sectional view illustrating rotation of one of the beater assemblies 40 against the underside of the conveyor belt 30.

### DETAILED DESCRIPTION OF THE INVENTION

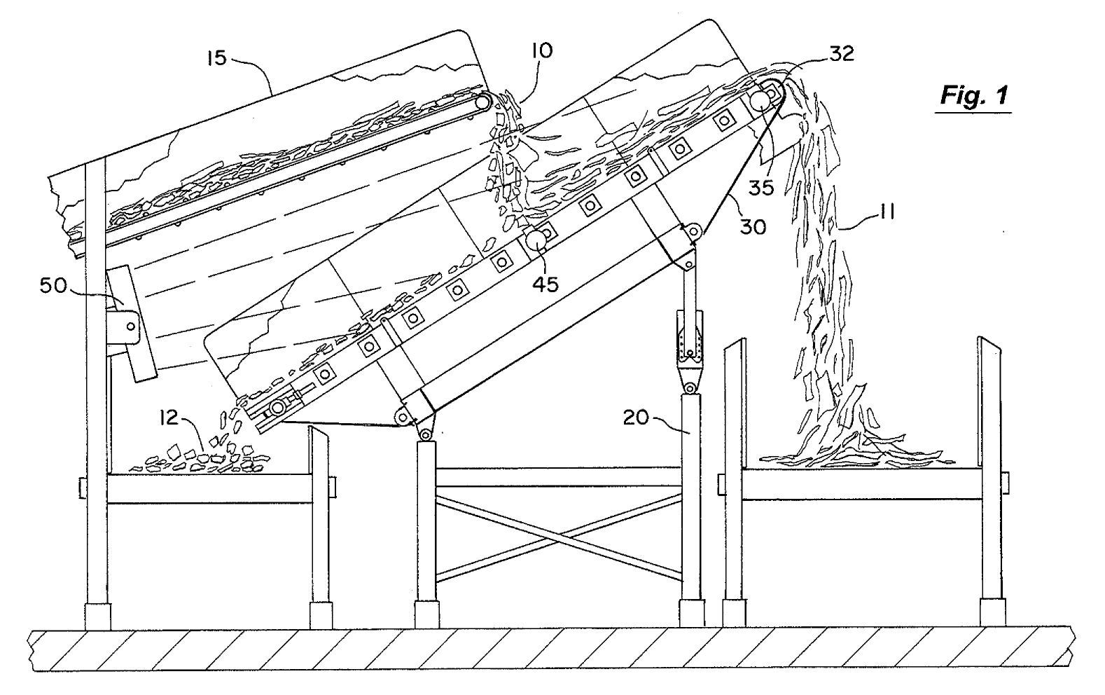

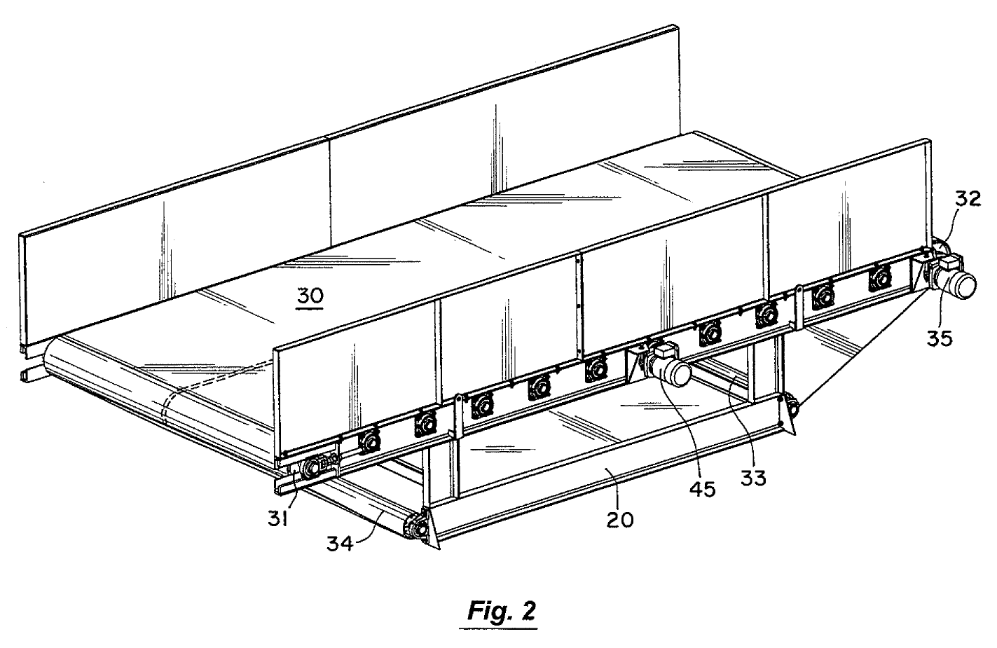

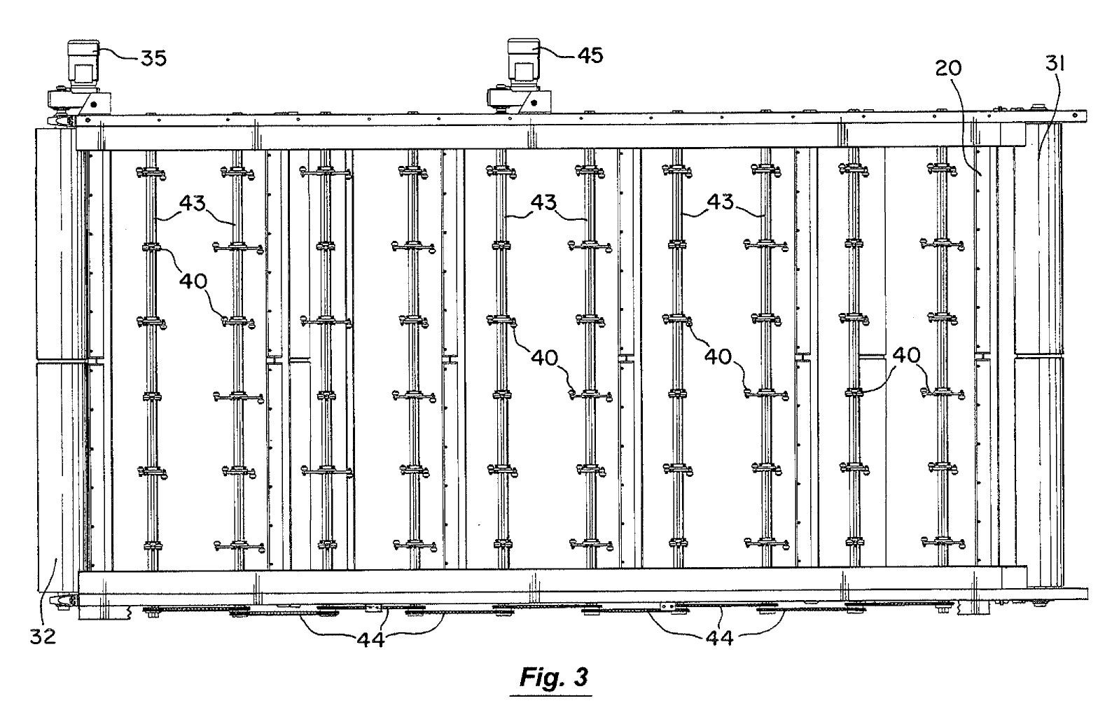

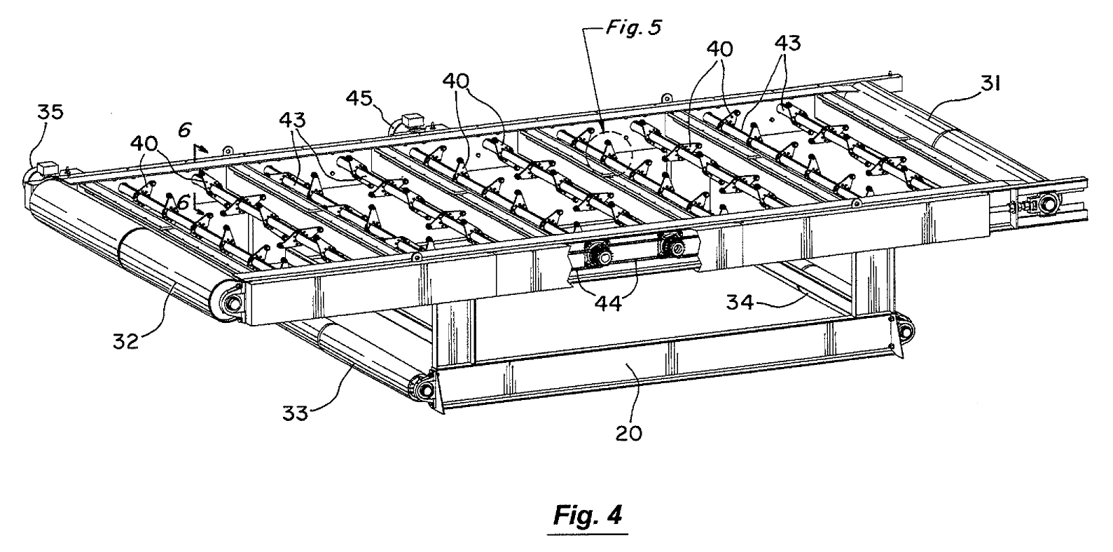

Turning to FIG. 1, a simplified side elevational view is provided showing an embodiment of the present invention in operation. A conveyor is held in an inclined orientation by a support frame 20. FIG. 2 is a corresponding perspective view of the conveyor. The conveyor includes an endless conveyor belt 30 that is guided and supported by a number of rollers 31, 32, 33 and 34. An electric motor 35 drives one of the rollers 32, which in turn drives the conveyor belt 30 so that the upper run of the conveyor belt 30 moves toward the upper end of the assembly. This is also shown in FIGS. 3 and 4. The rollers 31-34 can be equipped with a circumferential groove that engage a corresponding V-guide on the underside of the conveyor belt 30 to prevent lateral movement of the conveyor belt 30. In the preferred embodiment of the present invention, the conveyor has an upward pitch of about 40° to 45°. A feeder mechanism 15, such as an in-feed conveyor, is used to deposit a stream of mixed recycled materials 10 on the midsection of the conveyor belt 30 as shown in FIG. 1.

An array of rotating beaters 40 strike the underside of the conveyor belt 30. FIG. 3 is a top view of the conveyor with the conveyor belt 30 removed to reveal these beaters 40. FIG. 4 is a perspective view corresponding to FIG. 3. In this embodiment, the beaters 40 are mounted in rows on a series of parallel shafts 43 that extend across the support frame 10 beneath the upper run and above the lower run of the conveyor belt 30. An electric motor 45 directly drives one of the shafts 43, which then drives the remaining shafts 45 via drive chains 44, as depicted in FIGS. 3 and 4.

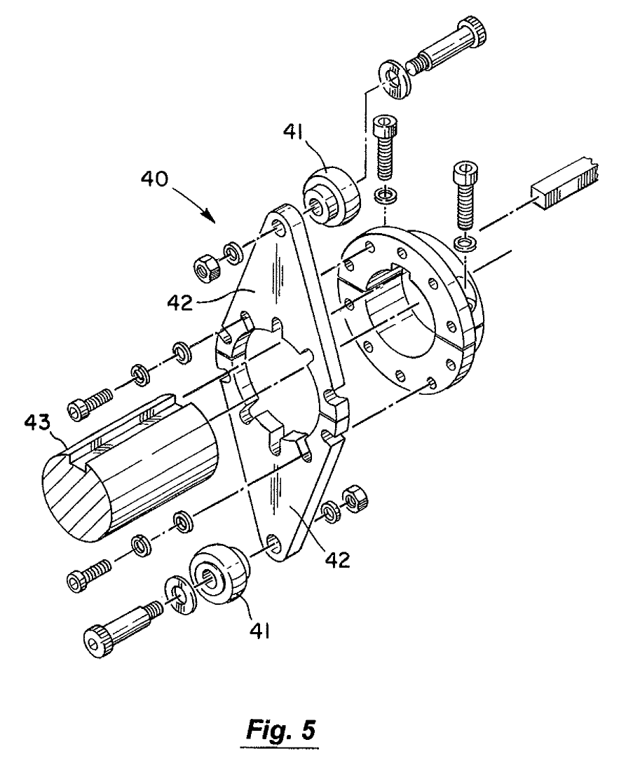

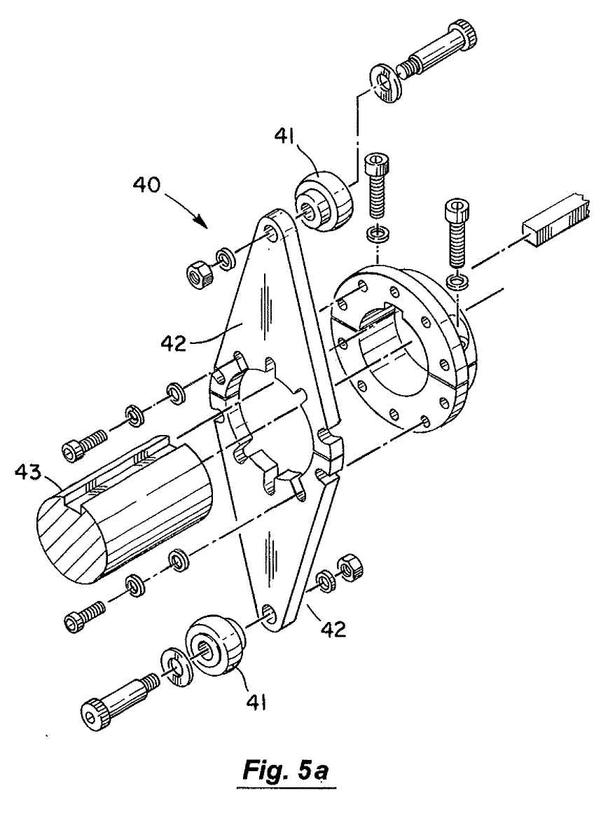

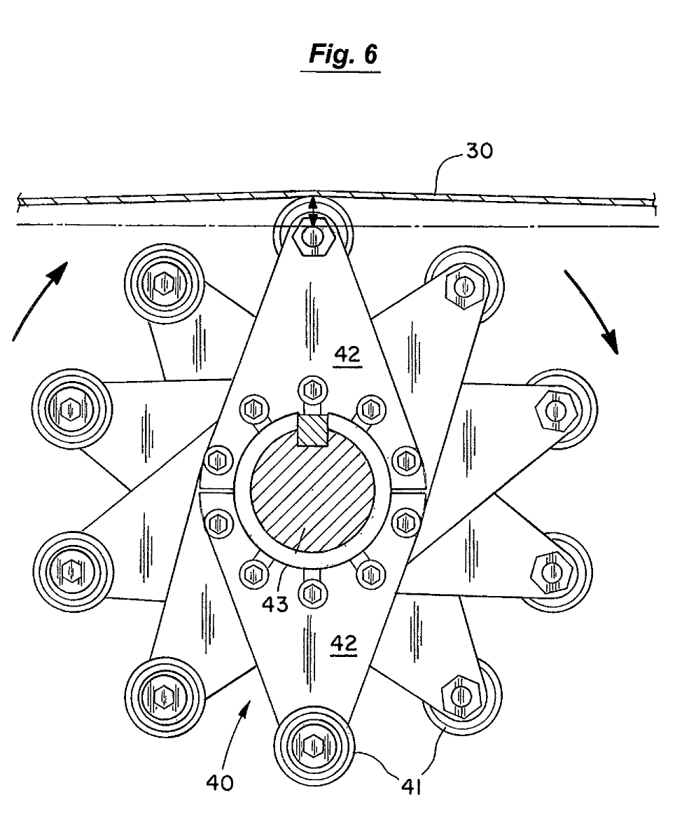

FIG. 5 is an exploded perspective view of one of the beater assemblies 40. Each beater 40 includes a number of elongated arms 42 extending radially outward from the drive shaft 43 to strike the underside of the conveyor belt 30. FIG. 6 is a side cross-sectional view illustrating rotation of one of the beater assemblies 40 against the underside of the conveyor 30. The embodiment of the beaters 40 shown in the drawings has two diametrically-opposed arms 42, so that each beater 40 strikes the conveyor belt 30 twice during each rotation of the drive shaft 43. It should be understood that the beaters 40 could be designed with any desired number of arms or protrusions. Each arm 42 can be equipped with a small wheel or roller 41, as shown in FIG. 5, to reduce friction and wear as the arms 42 contact the conveyor belt 30. In addition, the relative phases of the beaters 40 along the shafts 43 can be staggered, as shown in FIG. 4, to reduce the load placed on the drive motor 45 and make this load more uniform, and also to reduce wear on the conveyor belt 30.

Beaters 40 having arms of different lengths can be employed at different locations under the conveyor belt 30 to provide differing degrees of agitation to the recycled materials. For example, in the embodiment shown in FIGS. 3 and 4, the beaters 40 on the two drive shafts 43 adjacent to the upper end of the conveyor belt 30 have a slightly greater radius to increase agitation of the recycled materials. This helps to ensure that any cans or bottles approaching the upper end of the conveyor belts 30 are dislodged from the remaining recycled materials and fall to the lower end of the system. FIG. 5a is an exploded perspective view of one of these larger beater assemblies.

In operation, mixed recycled materials are deposited onto the midsection of the conveyor belt 30 by the feeder mechanism 15. Recycled materials can either be fed continuously or periodically in separate batches for processing. The impacts of the beaters 40 on the underside of the conveyor belt 30 are transmitted through the conveyor belt 30 to the mixed recycled materials on its upper surface. These impacts cause heavier recycled materials 12 (i.e., primarily cans and bottles) to bounce from the conveyor belt 30 and tumble to the lower end. In contrast, lighter two-dimensional recycled materials 11 (i.e., primarily paper and cardboard) tend to stay on the conveyor belt 30 and are carried by motion of the conveyor belt 30 to its upper end as shown in FIG. 1.

Optionally, a fan or blower 50 can be used to direct air against the upper surface of the conveyor belt 30 to hold lighter recycled materials 11 (e.g., paper and corrugated material) against the conveyor belt 30 as these materials are carried by the conveyor belt 30 to its upper end.

It should be understood that this separation process need not be 100% effective to be useful in the recycling industry. Recycled materials can be processed multiple times to achieve any desired quality control requirements for separation of different types of the materials. This can be done by multiple passes through the same equipment, or by a single pass through multi-stage equipment. The present invention can also be combined with other conventional equipment or processes for separating categories of recycled materials. For example, an initial fine screening stage can be used to remove broken glass.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A conveyor system for separating mixed recycled materials containing lighter and heavier recycled materials, said system comprising:
an inclined conveyor belt having an upper end, a lower end, a midsection between the upper and lower ends, and an underside; said conveyor belt forming an endless loop driven toward the upper end;
a feeder mechanism depositing mixed recycled materials onto the midsection of the conveyor belt; and
an array of rotating beaters striking the underside of the conveyor belt so that heavier recycled materials are bounced from the conveyor belt and tumble to the lower end, and lighter recycled materials are carried by motion of the conveyor belt to the upper end.

2. The conveyor system of claim 1 further comprising a fan directing air against the conveyor and thereby holding lighter recycled materials against the conveyor belt.

3. The conveyor system of claim 1 wherein the angle of inclination of the conveyor belt is in the range of approximately 40° to 45°.

4. The conveyor system of claim 1 wherein the beaters comprise a series of rows of beaters mounted on rotating shafts.

5. The conveyor system of claim 1 wherein the beaters comprise at least one arm mounting on an rotating shaft with a rotatable wheel on the arm striking the underside of the conveyor belt.

6. A conveyor system for separating mixed recycled materials containing lighter and heavier recycled materials, said system comprising:
an inclined conveyor belt having an upper end, a lower end, a midsection between the upper and lower ends, and an underside; said conveyor belt forming an endless loop driven toward the upper end;
a feeder mechanism depositing mixed recycled materials onto the midsection of the conveyor belt;
a fan directing air against the conveyor to hold lighter recycled materials against the conveyor belt; and
an array of rotating beaters striking the underside of the conveyor belt so that heavier recycled materials are bounced from the conveyor belt and tumble to the lower end, and lighter recycled materials are carried by motion of the conveyor belt to the upper end.

7. The conveyor system of claim 6 wherein the angle of inclination of the conveyor belt is in the range of approximately 40° to 45°.

8. The conveyor system of claim 6 wherein the beaters comprise a series of rows of beaters mounted on rotating shafts.

9. The conveyor system of claim 6 wherein the beaters comprise at least one arm mounting on an rotating shaft with a rotatable wheel on the arm striking the underside of the conveyor belt.

10. A method for separating mixed recycled materials containing lighter and heavier recycled materials comprising:
providing an inclined conveyor belt having an upper end, a lower end, a midsection between the upper and lower ends, and an underside; said conveyor belt forming an endless loop driven toward the upper end;
depositing mixed recycled materials onto the midsection of the conveyor belt; and
striking the underside of the conveyor belt with an array of rotating beaters so that heavier recycled materials are bounced from the conveyor belt and tumble to the lower end, and lighter recycled materials are carried by motion of the conveyor belt to the upper end.

11. The method of claim 10 further comprising directing air against the conveyor to hold lighter recycled materials against the conveyor belt.

12. The method of claim 10 wherein the angle of inclination of the conveyor belt is in the range of approximately 40° to 45°.
